(19) United States
(12) Patent Application Publication
(10) Pub. No.: US 2024/0179169 A1
(43) Pub. Date: May 30, 2024

(54) TECHNIQUES FOR VALIDATION AND OPTIMIZATION OF CLOUD COMPUTING ENVIRONMENTS

(71) Applicant: Cympire Ltd., Raanana (IL)

(72) Inventors: Ezequiel SEVELOFF, Arad (IL); Itay MIRON, Petach Tikva (IL); Yaniv SHACHAR, Tel Aviv (IL)

(73) Assignee: Cympire Ltd., Raanana (IL)

(21) Appl. No.: 18/058,984

(22) Filed: Nov. 28, 2022

(51) Int. Cl. H04L 9/40; G06F 9/50

(52) U.S. Cl. CPC H04L 63/1433; G06F 9/5022

(57) ABSTRACT

A system and method for validating a virtual range for simulating a cyberattack further optimizes the virtual range based on a cloud computing infrastructure. The method includes receiving a plurality of instructions for deploying the virtual range in a cloud computing environment, the plurality of instructions including an instruction to deploy a resource in the virtual range, and an instruction to initiate a simulated cyberattack respective of the resource; applying a validation test to a first instruction of the plurality of instruction; determining an execution order for the plurality of instructions, wherein the first instruction precedes a second instruction; and executing the second instruction in response to determining that the first instruction successfully completed execution and successfully completed the validation test.

### TECHNICAL FIELD

The present disclosure relates generally to cybersecurity and specifically to validating and optimizing cybersecurity virtual ranges to simulate cyber attacks.

### BACKGROUND

Cybersecurity is a field of technology which aims to protect, and prevent, computer systems from unwanted information disclosure, theft, damage, misdirection, disruption, and the like. However, despite the various technological solutions, one of the greatest flaws in computer systems is the human operator. Social engineering, misconfigurations, delays in updating systems known to contain security threats, all lead to cybersecurity issues which are a result of human error.

In tandem, while many threats can be stopped and mitigated automatically, it is often advantageous to have a human operator intervene in order to understand a broader context which a machine may not. For example, cybersecurity forensics is a field of endeavor where a human operator attempts to uncover what an attacker managed to accomplish in a computing environment, and provide context for various actions in the cloud computing environment which are not always apparent to a machine.

As in any field, a human operator is only as good as the training they receive. It is therefore beneficial to provide training facilities and resources to human operators, in order, for example, to measure their ability to respond to cybersecurity threats, to measure their ability to uncover and detect cybersecurity events, and to train them in order to improve their skill.

For this purpose, certain providers supply a cyber range, or range as a service, which provide a virtual environment in which cybersecurity threats are purposefully added to train human operators on how to respond to such threats. The virtual environments attempt to provide a realistic experience, and provide environments in which solutions can be tested without real-world repercussions.

Often, a cyber range is provided as a virtual environment deployed on a cloud service. While the environment is simulated, the threats are real, and so such environments must be contained and well defined. Any misconfiguration can potentially cause harm which ripples through the cloud environment, and possible to other cloud environments as well. On the other hand, such constraints make defining a range more difficult for a human operator, and more security constraints means less flexibility in how a range is deployed, and the amount of time it takes to deploy a range. It is useful to increase flexibility in order to train with different scenarios, and it is useful to decrease the amount of time it takes to deploy a range as this increases engagement with the range platform, which makes it more likely to be used by trainees.

It is advantageous to generate cyber ranges with multiple different scenarios, in order to practice different attack situations. However, planning such scenarios requires considerable preparation, due at least to some of the challenges noted above. While shortening this time would be advantageous, doing so quickly may lead to errors in the environment which would render the cyber range inoperable.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for validating a virtual range for simulating a cyberattack. The method comprises: receiving a plurality of instructions for deploying the virtual range in a cloud computing environment, the plurality of instructions including an instruction to deploy a resource in the virtual range, and an instruction to initiate a simulated cyberattack respective of the resource; applying a validation test to a first instruction of the plurality of instruction; determining an execution order for the plurality of instructions, wherein the first instruction precedes a second instruction; and executing the second instruction in response to determining that the first instruction successfully completed execution and successfully completed the validation test.

Certain embodiments disclosed herein also include a non-transitory computer readable medium having stored thereon causing a processing circuitry to execute a process, the process comprising: receiving a plurality of instructions for deploying the virtual range in a cloud computing environment, the plurality of instructions including an instruction to deploy a resource in the virtual range, and an instruction to initiate a simulated cyberattack respective of the resource; applying a validation test to a first instruction of the plurality of instruction; determining an execution order for the plurality of instructions, wherein the first instruction precedes a second instruction; and executing the second instruction in response to determining that the first instruction successfully completed execution and successfully completed the validation test.

Certain embodiments disclosed herein also include a system for validating a virtual range for simulating a cyberattack. The system comprises: a processing circuitry; and a memory, the memory containing instructions that, when executed by the processing circuitry, configure the system to: receive a plurality of instructions for deploying the virtual range in a cloud computing environment, the plurality of instructions including an instruction to deploy a resource in the virtual range, and an instruction to initiate a simulated cyberattack respective of the resource; apply a validation test to a first instruction of the plurality of instruction; determine an execution order for the plurality of instructions, wherein the first instruction precedes a second instruction; and execute the second instruction in response to determining that the first instruction successfully completed execution and successfully completed the validation test.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example illustration of a graphical user interface for generating a cybersecurity virtual environment, implemented in accordance with an embodiment.

FIG. 2 is a schematic diagram of a virtual range generated by a range server and verified by a validation server, implemented in accordance with an embodiment.

FIG. 3 is a flowchart of a method for deploying a virtual range, implemented in accordance with an embodiment.

FIG. 4 is a flowchart of a method for terminating a virtual range, implemented in accordance with an embodiment.

FIG. 5 is a flowchart of a method for generating an alternate virtual range based on received instructions, implemented in accordance with an embodiment.

FIG. 6 is a schematic diagram of a validation server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for validating and optimizing virtual ranges for simulating cybersecurity attacks are disclosed. In an embodiment, validating a cybersecurity virtual range includes applying a validation on an instruction generated to deploy a virtual range. A validation includes a rule, in an embodiment. In certain embodiments, a validation is a technical validation, a logical validation, a combination thereof, and the like. A technical validation is a rule for validating that a technical configuration is correct. For example, a technical validation may be to ensure that each deployed machine includes at least 8 Gb of memory. A logical validation is a rule for validating that logical definitions of the virtual range are implemented according to predefined schema. For example, a logical definition ensures that a deployed virtual machine includes a network address assigned to a subnet, and that the subnet is part of a virtual private cloud.

In certain embodiments, the system is configured to generate an alternate virtual range, in response to determining that the alternate virtual range requires less allocated resources from the cloud computing environment than the virtual range. For example, in an embodiment the system is configured to detect an application deployed by an instruction of the instructions for generating a range. The system is configured to determine if the machine, such as the virtual machine, on which the application is to be deployed in the virtual range has sufficient compute resources (e.g., enough memory, enough processing power, etc.). In an embodiment, the system is further configured to determine if the machine on which the application is to be deployed is allocated more resources than is required to execute the application (e.g., too much memory). In such embodiments, the system is configured to generate an alternate virtual range in place of the virtual range, and deploy therein a second machine in place of the machine specified in the virtual range, wherein the second machine is configured with allocated resources which are predetermined to be sufficient to execute the application, such that the second machine is allocated less resources than the original machine.

In some embodiments, the system is further configured to terminate the virtual range. Terminating a virtual range includes deallocating, deprovisioning, and otherwise releasing resources allocated to the virtual range. Terminating the virtual range allows the cloud computing environment to provision the resources allocated to the virtual range to other uses, thereby increasing the usability of the cloud computing environment as a whole. Furthermore, use of the cloud computing environment is often associated with a cost, and where time of use is reduced, cost is reduced, which is always beneficial. In certain embodiments, the system is configured to detect resources which are active only for a part of the cyber attack simulation, and terminates such resources (i.e., releases the allocation of such resources) immediately upon completion of their function.

In this regard, it is recognized that human operators may manually determine execution order of instructions, manually determine when to release compute resources allocated to a virtual range, and generate alternate virtual ranges. However, a human determining an order in which to execute a plurality of instructions cannot do so reliably, especially with cloud computing environments including hundreds of components, each component interlinked with others. Furthermore, a human is not capable of reliably and consistently applying criteria by which to decide what instructions need to be executed prior to or post other instructions, especially when in some cases an instruction which needs to be executed prior in a first virtual range, needs to be executed post in another virtual range. The present disclosure solves at least this by providing a system which reliably, consistently, and objectively applies predetermined criteria in determining an order by which to execute instructions for deploying a virtual range.

In addition, a human is not capable of reliably and consistently applying objective criteria by which to determine when a resource of a virtual range should be deallocated. Furthermore, the sheer amount of resources allocated even to a modest virtual range is large and must be deallocated in a specific order at a specific time. The present disclosure solves at least this by providing a system which applies objective criteria reliably and consistently by which resources are deallocated form a virtual range, resulting in no formation of leftover artifacts, which waste compute resources.

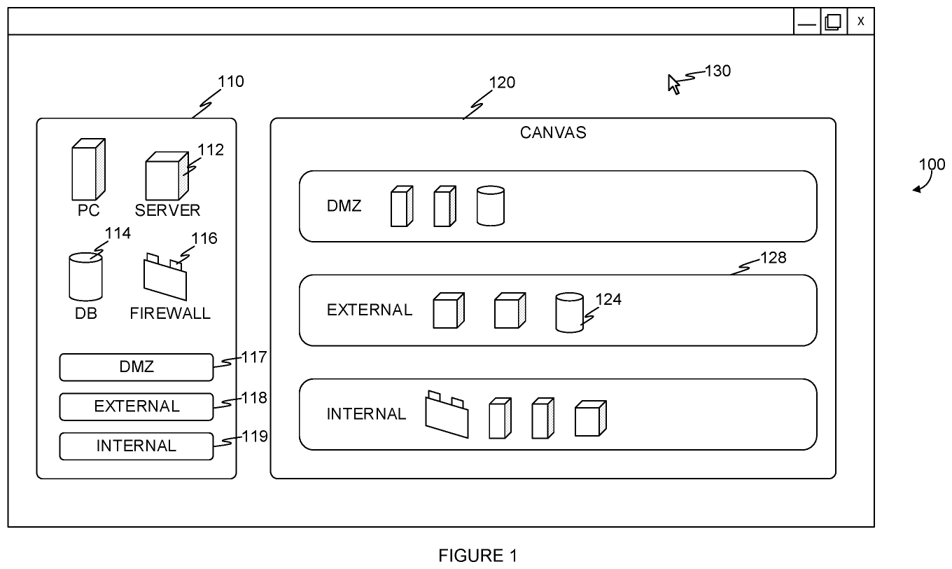

FIG. 1 is an example illustration of a graphical user interface for generating a cybersecurity virtual environment, implemented in accordance with an embodiment. A graphical user interface 100 (GUI 100) includes a stencil 110 and a canvas 120. In an embodiment, the stencil 110 includes graphical representations, such as icons, which each represent a network entity. In certain embodiments, a network entity is a computer, such as server 112, a service such as database 114, firewall 116, and the like, a user, a role, a user group, and the like.

A network entity, when deployed in a network environment such as a cloud computing environment, may be a cloud entity. A cloud entity may be, for example, a resource, a principal, and the like. A principal is a cloud entity which acts on a resource, and in an embodiment is configured to initiate actions in the cloud computing environment. A user account, service account, and a role are examples of a principal.

A resource is a cloud entity which provides a service, or access to a compute resource, such as a processor, a memory, a storage, combinations thereof, and the like. In an embodiment, a resource is any one of a virtual machine, a container, a serverless function, and the like. In certain embodiments a resource is an application, such as a web application firewall, a virtual appliance, a database management system (DBMS), a load balancer, a proxy server, and the like. In some embodiments, a cloud entity may be both a principal and a resource. For example, a load balancer is a principal with respect to a web server on which it acts and initiates actions, a resource with respect to a user account which acts on the load balancer, for example, to access the web server.

In an embodiment, the stencil 110 further contains representations of subnetworks, such as DMZ 117, external network 118, and internal network 119. In an embodiment, each representation displayed in the stencil 110 is associated with instructions which when executed configure a computer system, such as detailed below, to generate a virtual instance, environment, and the like, which corresponds to the representation, or to a customized version of the representation, according to an embodiment.

In an embodiment, the GUI 100 is configured to interact with a user by receiving input from a cursor, such as pointer 130. For example, an input may be detecting the cursor on, or in proximity of, a representation, such as server 112. In an embodiment the GUI 100 is configured to receive an input indicating, for example, a ‘click’ or a ‘drag and drop’, such that the cursor clicks on the external network 118 of the stencil 110, drags the representation of the external network 118 to the canvas 120 to generate an external network representation 128 in the canvas 120. Network entities may be dragged and dropped into the external network representation 128, for example, by dragging database 114 to the external network representation 128 and generating a database 124 therein by dropping the representation 114 into the external network representation 128.

In an embodiment, a network entity may be preconfigured. For example, the server 112 may be preconfigured as a virtual machine having a Microsoft® Windows® operating system (OS) running an Apache® HTTP Server. In certain embodiments, once a network entity is dragged into a canvas, the network entity may be further configured, for example by changing metadata associated with the network entity. For example, the database 124 may be customized by changing metadata associated with visual representation. Metadata may be, for example, a database type, database management system (DBMS) version, and the like. In an embodiment a database type is a SQL database, a NoSQL database, and the like. For example, an SQL database may be a relational database such as MySQL. A NoSQL database may be, for example, MongoDB, Neo4j, and the like. In an embodiment, the GUI 100 is configured to receive an input, such as a double-click from an input device when the cursor 130 is positioned over or near the visual representation of the database 124. In an embodiment, the input, when received, configures the GUI 100 to display metadata associated with the database 124. A user may provide additional input to the GUI 100 to change the metadata.

In an embodiment, the canvas 120 is a visual representation of a range environment which a user wishes to deploy, for example in a cloud computing environment. Dragging and dropping are a form of providing input which human operators find intuitive, thus allowing to a human operator to define a representation of a network environment in the canvas 120.

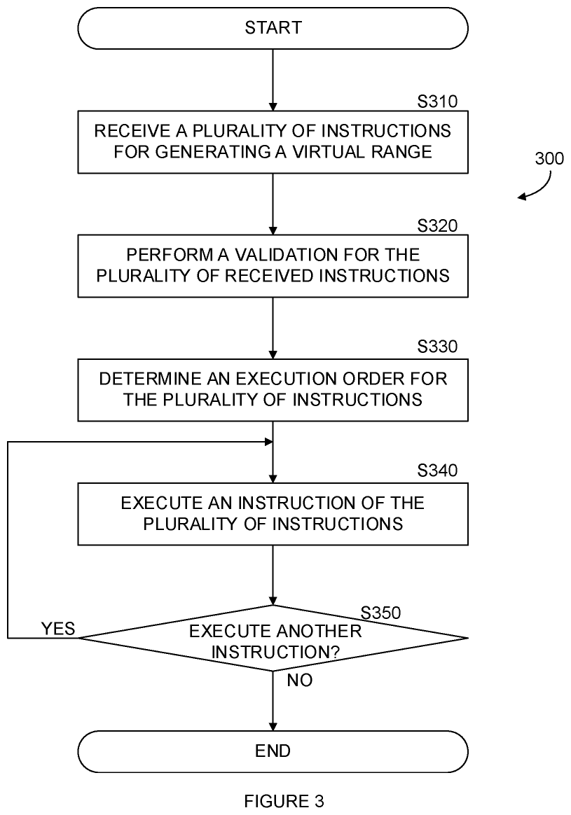

In an embodiment, a range server (not shown) is configured to receive input from the GUI 100, for example from the canvas 120, and generate a range based on the received input. An example of a range server is discussed in more detail with respect to FIG. 3 below.

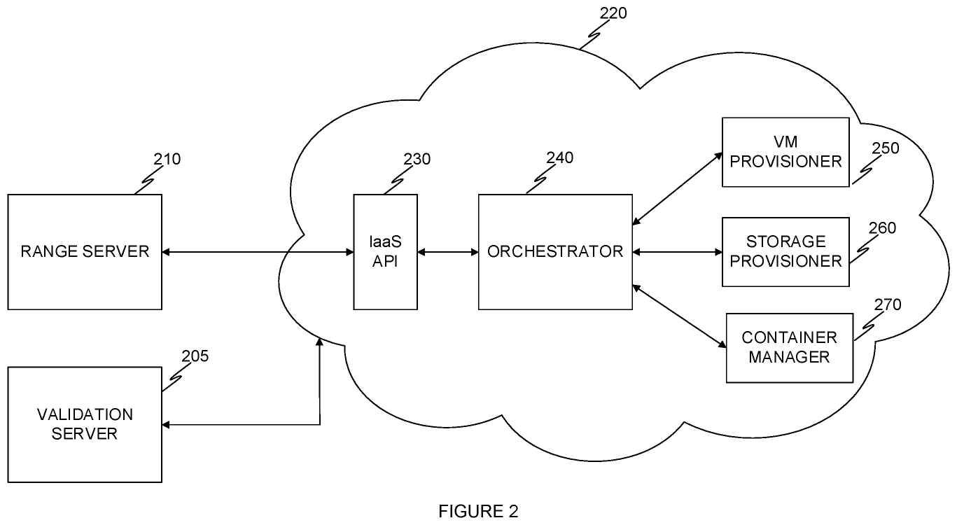

FIG. 2 is an example of a schematic diagram of a virtual range generated by a range server and verified by a validation server, implemented in accordance with an embodiment. In an embodiment, a range server 210 is configured to receive input from a GUI, such as GUI 100 of FIG. 1 above. In certain embodiments, a range server 210 is implemented as a virtual machine, a software container, a serverless function, and the like. In an embodiment, the range server 210 further includes a rule engine which is configured to receive an input and generate an instruction output, the instruction when executed by an orchestrator of a cloud computing environment, causes initiation of an action in the cloud computing environment.

For example, the range server 210 is configured in an embodiment to receive an input from a GUI utilized to generate a schematic illustration of a virtual range. In an embodiment, the input includes a data structure, including a representation of a plurality of network elements, each network element associated with metadata and a relative location. In an embodiment, the relative location and metadata are provided to the rule engine of the range server 210 to determine what instruction to generate for generating a corresponding virtual instance in a cloud computing environment.

For example, in an embodiment, a rule engine is configured to detect that a virtual instance is represented in a representation of the subnet. The rule engine is configured to output an instruction which when executed configures a virtual instance to have an address corresponding to the subnet. In an embodiment, the range server 210 is configured to generate instructions for an application programming interface (API) of an Infrastructure as a Service (IaaS) 230 of a cloud computing infrastructure 220. For example, cloud computing infrastructure 220 may be provided by Amazon® Web Services (AWS), Google® Cloud Platform (GCP), Microsoft® Azure, and the like.

In an embodiment, where the cloud computing infrastructure 220 is provided by AWS, the range server 210 is configured to generate the instructions using Boto3, which is a software development kit (SDK) for AWS infrastructure services. Generating instructions through the IaaS API 230, when executed by an orchestrator 240 of the cloud computing infrastructure 220, configure the cloud computing infrastructure 220 to initiate an action therein. By configuring the cloud computing infrastructure 220 to initiate actions through the IaaS API 230, the actions are initiated without a markup language file, which would otherwise be required in order to initiate the actions. For example, a virtual machine can be initiated through the IaaS API 230, or by providing a YAML file. YAML files are typically provided by a user, for example, by manually typing code of the markup language. This is prone to errors, misconfigurations, and is a time consuming process. Therefore, by initiating the virtual machine through the IaaS API 230 in place of providing a YAML file, human error is reduced, allowing to deploy a virtual range in a more expedient manner.

In some embodiments, the range server 210 is configured to determine an order of execution for the instructions. This is advantageous as certain instructions need to be completed before other instructions are executed, according to an embodiment. For example, in an embodiment the range server 210 is configured to initiate an instruction which performs a cybersecurity attack in response to determining that a virtual range, and all components thereof, have been successfully deployed. For example, in an embodiment the range server 210 is configured to determined that a component is deployed in a virtual range by sending a network communication to the component.

In an embodiment, an orchestrator 240 is a implemented as a virtual machine, a software container, a serverless function, a combination thereof, and the like, in order to initiate certain actions in the cloud computing infrastructure 220. For example, an action may be to initialize a virtual machine, initialize a serverless function, deploy a node in a container cluster, deploy a container cluster, provision infrastructure, provision a platform, provision an application, a combination thereof, and the like. For example, in an AWS environment, UiPath™ provides orchestration services.

In certain embodiments, the orchestrator 240 is configured to initiate actions utilizing a service in the cloud computing infrastructure 220. For example, a service may be a virtual machine provisioner 250, such as provided by Amazon® Elastic Compute Cloud (EC2). In some embodiments a service is a storage provisioner 260, such as Amazon Simple Storage Service (S3). In yet other embodiments a service is a container manager 270, such as Amazon® Elastic Kubernetes™ Service (EKS), which utilizes a Kubernetes orchestration system to provision and manage software containers.

In an embodiment, the validation server 205 is implemented as a virtual machine, a software container, a serverless function, a combination thereof, and the like. In certain embodiments, the validation server 205 is configured to receive instructions for deploying a virtual range, the instructions generated by a range server 210. In an embodiment, the validation server 205 is configured to determine an order by which each of the received instructions needs to be executed. For example, a VPC needs to be deployed before a virtual machine utilizing a subnet of the VPC is deployed. As another example, elements of the virtual range, such as a database, a virtual machine, and the like, need to be deployed prior to initializing a simulated attack. In an embodiment, initializing a simulated attack includes generating an instruction which, when executed, exploits a cybersecurity vulnerability associated with a resource deployed in the virtual range. In some embodiments, initializing a simulated attack includes generating an instruction which stores an artifact, for example in a storage, in the virtual range. An artifact may be, for example, a data entry in a database, a file stored in a storage bucket, a network log entry, and the like.

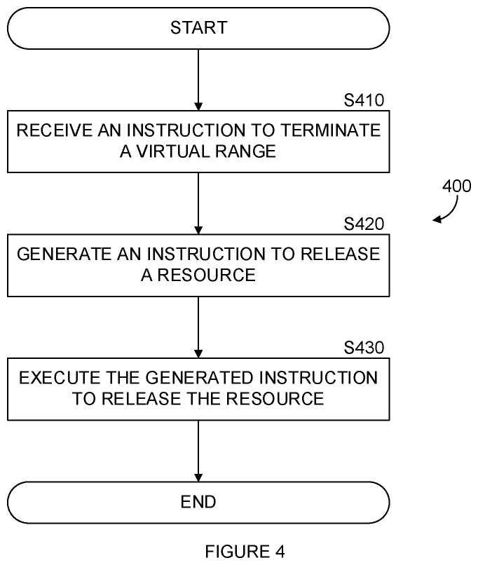

In certain embodiments, the validation server 205 is further configured to terminate a virtual range. Terminating a virtual range includes deprovisioning, or causing deprovisioning of, resources allocated to the virtual range. For example, terminating a virtual range includes, in an embodiment, releasing volume claims on storage resources, deallocating processing power, and the like. An example method for terminating a virtual range is discussed in more detail in FIG. 4 below.

In some embodiments, the validation server 205 is configured to generate an alternate virtual range configuration. For example, the validation server 205 is configured, in an embodiment, to receive instructions for generating a virtual range deployed in a cloud computing environment, and determining an amount of compute resources required to deploy the virtual range based on the received instructions. In some embodiments, the validation server 205 is configured to determine an amount of compute resource, such as an amount of processing, an amount of computer memory, an amount of storage, a combination thereof, and the like, for deploying a virtual range based on the received instructions. In an embodiment, the validation server 205 is configured to generate an estimate of an amount of compute resources for a time period. For example, an estimate is generated based on receiving data from a previous virtual range deployment, determining from the received data an amount of resources utilized by components of the previously deployed virtual range, and matching components from the received instructions to components of the previously deployed virtual range.

For example, a database of a previously deployed virtual range utilized a determined amount of IOPS, a determined storage size, a determined amount of processing time (e.g., CPU time), a combination thereof, and the like. An instruction to deploy a database therefore can be matched to data of compute resource usage of the previous deployed database and an estimate generated for the usage of the database deployed based on the instruction. In certain embodiments, a plurality of such data is utilized, for example as averaged data.

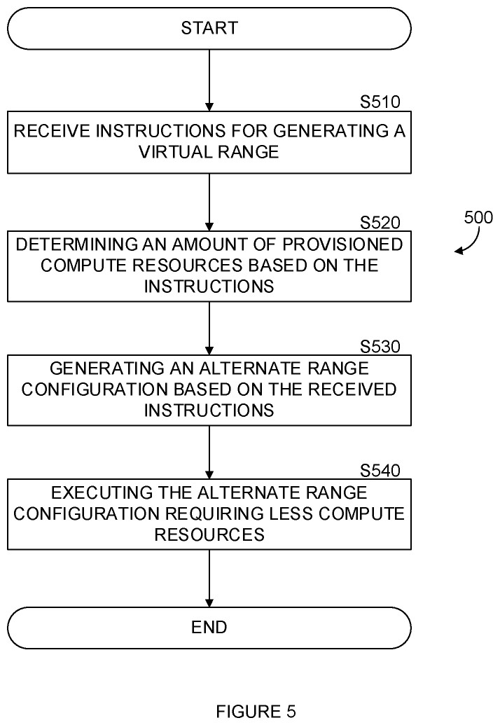

In some embodiments, the validation server 205 is configured to generate an alternate virtual range based on the received instructions. For example, the validation server 205 is configured, in an embodiment, to generate an alternate virtual range requiring less computational resources than a virtual range deployed based on the received instructions. In some embodiments, the validation server 205 is configured to detect a first resource (e.g., a first VM) and a second resource (e.g., a second VM) each configured to perform an action in the virtual range, and generate an instruction for deploying a third VM in place of the first VM and the second VM. In an embodiment the third VM is configured to perform the actions of both the first VM and the second VM. For example, the third VM is configured to initiate an action which the first VM is configured to initiate, and a second action which the second VM is configured to initiate, wherein the first VM is not configured to initiate the second action. A method for generating an alternate range is discussed in more detail in FIG. 5 below.

FIG. 3 is an example flowchart of a method for deploying a virtual range, implemented in accordance with an embodiment. A virtual range used for cyberattack simulations needs to be deployed in certain order, i.e., various resources have to be deployed in order, and various actions may further be required to be deployed in order. For example, initializing actions which simulate an attack on a resource which was not yet deployed would render the simulation ineffective. It is therefore advantageous to determine an order in which to execute instructions, and further determine that, for example, an action caused by executing an instruction is complete prior to executing a superseding instruction.

At S310, a plurality of instructions are received for generating a virtual range. In an embodiment, the instructions are generated based on a visual input, such as discussed in more detail in FIG. 1 above. In certain embodiments, the plurality of instructions includes an instruction for deploying a resource in the virtual range, and an instruction for simulating a cyberattack based on the deployed resource.

In an embodiment, simulating a cyberattack includes initiating an action which triggers a vulnerability on a deployed resource. In certain embodiments, simulating a cyberattack includes initiating an action which exploits a misconfiguration on a deployed resource. For example, an action which exploits a misconfiguration includes, in an embodiment, generating a code, and injecting the code into an application hosted on a resource in the virtual range.

At S320, a validation is performed. In certain embodiments, validation is performed utilizing the plurality of instructions. In an embodiment, performing validation includes applying a rule on a portion of the plurality of instructions. In some embodiments, a validation is a technical validation, a logical validation, a combination thereof, and the like. A technical validation is a validation which ensures that an instruction is technically valid. For example, a technical validation is, in an embodiment, to determine that a virtual machine is associated with a minimum memory amount and minimum CPU. In an embodiment, a logical validation ensures that virtual components are well-defined within a framework. For example, a network validation, which is a type of logical validation, includes a rule that when applied determines if an instance (e.g., a virtual machine) has an IP address which is in the range of a subnet associated with the instance, and that the subnet has a range of IP addresses which is within a range of a VPC with which the subnet is associated.

As another example, a security validation is a logical validation which ensures that a security group policy is applied to every instance associated with the security group.

In some embodiments, a portion of the plurality of instructions are stored as a template from which a component of the virtual range is deployed. Generating a virtual range based on a template is discussed in more detail in U.S. Non-Provisional patent application Ser. No. 17/819,153, assigned to common assignee, the entire contents of which are incorporated by reference herein. In an embodiment, an instruction template is validated prior to launching an instance based off of the template. For example, validation includes in an embodiment a verification that a software license is valid, and that the machine allocated to execute the software is capable of performing such execution (e.g., in terms of processing, memory, etc.). In some embodiments, validation includes determining that the machine allocated to execute the software is over capable of executing the software. In such embodiments, an indication may be generated, for example displayed to a user on a display, which indicates that the software is more suitable for execution on a machine having less capability than the one selected. This may reduce wasting allocated resources, and reduce cost of operation.

In certain embodiments, a user-generated validation is applied to a portion of the received instructions. A user generated validation includes, in an embodiment, a rule which is applied to a received instruction.

At S320, an execution order is determined for the received instructions. In an embodiment, a portion of the plurality of instructions are determined to be executed in no particular order, in parallel, and the like. In certain embodiments, a first instruction is determined to be superseding a second instruction, meaning that execution of the second instruction must be complete before execution of the first instruction. For example, a VPC needs to be generated before a subnet, and a subnet and VPC need to be deployed before a resource, such as a virtual machine, can be deployed in the VPC. As another example, a cyberattack simulation may initiate only once the virtual machine is deployed.

Each of the above mentioned instructions may be directed at a different provisioning service in the cloud computing environment. If the instructions are all provided at once, for example, execution occurs out of order, resulting in a virtual range which fails to achieve its purpose. In certain occurrences, a virtual range may altogether fail to deploy if instructions are not performed in a correct order. It is therefore advantageous to determine such an order, by which the instructions are executed.

At S330, an instruction of the plurality of instructions is executed. In an embodiment, executing an instruction to deploy a virtual range includes providing the instruction to an orchestrator which provisions compute resources to the virtual range. In certain embodiments, a response is received as a result of initiating execution of the instruction. The result may be, for example, an indication that the instruction was executed successfully, an indication that the instruction was executed unsuccessfully, and the like. In some embodiments, the response is recorded. Recording a response may be performed, for example, by storing the response in a log. In certain embodiments the response and a time at which the response is received are stored in a log.

At S340, a check is performed to determine if another instruction should be executed. If ‘no’ execution terminates. In an embodiment, another instruction is determined to be executable if the preceding instruction (e.g., the instruction executed at S330) completed execution. In an embodiment, a check is performed to determine if the preceding instruction successfully executed. If ‘yes’ execution continues at S330. If the preceding instruction was not completed yet, another check may be performed at a later, predefined, time to determine if the preceding instruction is complete at the later time. If the preceding instruction has failed to executed, in an embodiment, execution may terminate. In such embodiments, a notification is generated to indicate that the virtual range deployment has failed.

In certain embodiments, an instruction which is not successfully completed is attempted again, for example a predetermined number of times. In some embodiments, an instruction is repeated until a successful outcome is indicated.

FIG. 4 is an example flowchart of a method for terminating a virtual range, implemented in accordance with an embodiment. Terminating a virtual range is desirable once a simulation is complete, as this allows to free the resources allocated to the virtual range. In certain embodiments, resources may be freed prior to the cyberattack simulation being complete, in order to reallocate previously allocated resources as quickly as possible, thus increasing their availability for other purposes.

Furthermore, deallocating resources from the virtual range decreases costs of operating such an environment, as the cost is often tied to a period of time a resource is allocated to the virtual range, whether such resource is in actual use or not. For example, a 1 TB storage allocated to a virtual range may be billed by a cloud service provider whether the storage is currently in use or not, for as long as the storage is allocated. It is therefore desirable to reduce time resources are allocated in order to improve efficiency and reduce cost.

At S410, an instruction to terminate a virtual range is received. In an embodiment, the instruction includes an identifier of the virtual range, an identifier of a component of the virtual range, a combination thereof, and the like. In certain embodiments a component is a resource, such as a virtual machine, an appliance, a VPC, and the like. In certain embodiments, the instruction to terminate the virtual range is predetermined, for example a virtual range is set to be active for a predefined time period (e.g., forty minutes). Terminating an environment may result in leftovers, i.e., processes, machines, configurations, and the like which were not terminated. This can occur for example in complicated computing environment having multiple components which may or may not be interlinked. Performing manual termination of a cloud environment can result in such leftovers, which ultimately translate into compute resources which are not deallocated, deprovisioned, or otherwise released. This is undesirable as these resources are then not provisioned to other uses, and furthermore they continue to incur costs.

At S420, an instruction to release a resource is generated. In some embodiments, release instructions are generated in response to receiving an instruction to terminate a virtual range. A release instruction is generated based on a previously generated instruction used to deploy the virtual range. For example, an instruction to release a pod in a software container is generated, in an embodiment, in response to an instruction which when executed caused the pod to be allocated in the software container. Generating release instructions based on instructions used to deploy the virtual range ensure that any resource allocated to the virtual range is deprovisioned, deallocated and otherwise released from the virtual range.

At S430, the generated release instruction is executed. In an embodiment, executing the generated release instruction includes providing the release instruction to a provisioning service of a cloud service provider. In an embodiment, where a cloud computing infrastructure is provided by AWS, an instruction for generating the virtual range utilizes Boto3, which is an SDK for AWS infrastructure services. A release instruction is generated therefore also utilizing Boto3, based on the instruction for generating the virtual range. Execution of the generated instruction includes, in an embodiment, providing the Boto3 instruction of an AWS infrastructure service.

FIG. 5 is an example flowchart of a method for generating an alternate virtual range based on received instructions, implemented in accordance with an embodiment.

At S510, a plurality of instructions for generating a virtual range are received. In an embodiment, the instructions are generated based on a visual input, such as discussed in more detail in FIG. 1 above. In certain embodiments, the plurality of instructions includes an instruction for deploying a resource in the virtual range, and an instruction for simulating a cyberattack based on the deployed resource. In some embodiments, the instruction of deploying a resource (e.g., virtual machine) includes a specification of any one of: a memory amount, a processor amount, a storage amount, a combination thereof, and the like.

At S520, an amount of provisioned compute resources is determined based on the received instructions. In certain embodiments, a compute resource is any one of: a processor, a memory, a storage, a combination thereof, and the like. In an embodiment the amount of provisioned compute resources is based on a time period. For example, an estimate is generated based on receiving data from a previous virtual range deployment, determining from the received data an amount of resources utilized by components of the previously deployed virtual range, and matching components from the received instructions to components of the previously deployed virtual range.

For example, a database of a previously deployed virtual range utilized a determined amount of IOPS, a determined storage size, a determined amount of processing time (e.g., CPU time), a combination thereof, and the like. An instruction to deploy a database therefore can be matched to data of compute resource usage of the previous deployed database and an estimate generated for the usage of the database deployed based on the instruction. In certain embodiments, a plurality of such data is utilized, for example as averaged data.

At S530, an alternate virtual range configuration is generated based on the received instructions. In an embodiment, an alternate virtual range requires less computational resources than a virtual range deployed based on the received instructions. For example, the virtual range includes, in an embodiment, instructions for deploying a virtual machine having 32 Gb of memory allocated thereto. However, an application deployed on the virtual machine is capable of executing properly on a virtual machine utilizing 16 Gb of memory. In an embodiment, in response to detecting an instruction to deploy the application on the virtual machine, instructions for configuring an alternate range are generated, which include deploying a second virtual machine instead of the virtual machine, the second virtual machine having allocated less memory resources than the virtual machine.

At S540, the alternate virtual range configuration is deployed. In an embodiment, the alternate virtual range configuration is deployed in response to determining that the alternate virtual range configuration requires less computational resources than a virtual range generated based on the received instructions.

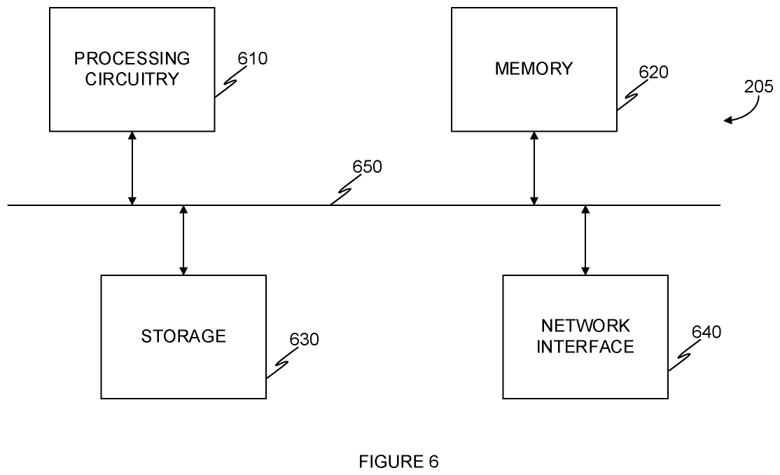

FIG. 6 is an example schematic diagram of a validation server 205 according to an embodiment. The validation server 205 includes a processing circuitry 610 coupled to a memory 620, a storage 630, and a network interface 640. In an embodiment, the components of the validation server 205 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the validation server 205 to communicate with, for example, the range server 210.

It should be understood that the embodiments described herein are not limited to the specific architecture illustrated in FIG. 6, and other architectures may be equally used without departing from the scope of the disclosed embodiments.

Furthermore, in certain embodiments the range server 210 may be implemented with the architecture illustrated in FIG. 6. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for validating a virtual range for simulating a cyberattack, comprising:
receiving a plurality of instructions for deploying the virtual range in a cloud computing environment, the plurality of instructions including an instruction to deploy a resource in the virtual range, and an instruction to initiate a simulated cyberattack respective of the resource;
applying a validation test to a first instruction of the plurality of instruction;
determining an execution order for the plurality of instructions, wherein the first instruction precedes a second instruction; and
executing the second instruction in response to determining that the first instruction successfully completed execution and successfully completed the validation test.

2. The method of claim 1, wherein the validation test is any one of: a logical validation, a technical validation, and a combination thereof.

3. The method of claim 1, wherein the first instruction is the instruction to deploy the resource and the second instruction is the instruction to initiate a simulated cyberattack.

4. The method of claim 1, further comprising:
terminating the virtual range, in response to determining that a cyberattack simulation is complete.

5. The method of claim 4, further comprising:
generating a plurality of release instructions, the release instructions when executed configure the cloud computing environment to release resources of the cloud computing environment allocated to the virtual range.

6. The method of claim 5, wherein the plurality of release instructions are generated based on the received plurality of instructions.

7. The method of claim 1, further comprising:
determining an amount of a compute resource utilized by the virtual range.

8. The method of claim 7, further comprising:
generating an alternate virtual range configuration based on the received plurality of instructions, wherein the alternate virtual range configuration utilizes less than the determined amount of computed resource utilized by the virtual range.

9. The method of claim 8, further comprising:
detecting an instruction for deploying an application in the plurality of instructions, the application deployed on a first virtual instance;
determining that the application can be executed on a second virtual instance requiring less compute resources than the first virtual instance; and
generating the alternate virtual range configuration to deploy the second virtual instance in place of the first virtual instance.

10. A non-transitory computer readable medium having stored thereon instructions for causing a processing circuitry to execute a process, the process comprising:
receiving a plurality of instructions for deploying the virtual range in a cloud computing environment, the plurality of instructions including an instruction to deploy a resource in the virtual range, and an instruction to initiate a simulated cyberattack respective of the resource;
applying a validation test to a first instruction of the plurality of instruction;
determining an execution order for the plurality of instructions, wherein the first instruction precedes a second instruction; and
executing the second instruction in response to determining that the first instruction successfully completed execution and successfully completed the validation test.

11. A system for validating a virtual range for simulating a cyberattack, comprising:
a processing circuitry; and
a memory, the memory containing instructions that, when executed by the processing circuitry, configure the system to:
receive a plurality of instructions for deploying the virtual range in a cloud computing environment, the plurality of instructions including an instruction to deploy a resource in the virtual range, and an instruction to initiate a simulated cyberattack respective of the resource;
apply a validation test to a first instruction of the plurality of instruction;
determine an execution order for the plurality of instructions, wherein the first instruction precedes a second instruction; and
execute the second instruction in response to determining that the first instruction successfully completed execution and successfully completed the validation test.

12. The system of claim 11, wherein the validation test is any one of: a logical validation, a technical validation, and a combination thereof.

13. The system of claim 11, wherein the first instruction is the instruction to deploy the resource and the second instruction is the instruction to initiate a simulated cyberattack.

14. The system of claim 11, wherein the memory contains further instructions which when executed by the processing circuitry further configures the system to:
terminate the virtual range, in response to determining that a cyberattack simulation is complete.

15. The system of claim 14, wherein the memory contains further instructions which when executed by the processing circuitry further configures the system to:
generate a plurality of release instructions, the release instructions when executed configure the cloud computing environment to release resources of the cloud computing environment allocated to the virtual range.

16. The system of claim 15, wherein the plurality of release instructions are generated based on the received plurality of instructions.

17. The system of claim 11, wherein the memory contains further instructions which when executed by the processing circuitry further configures the system to:
determine an amount of a compute resource utilized by the virtual range.

18. The system of claim 17, wherein the memory contains further instructions which when executed by the processing circuitry further configures the system to:
generate an alternate virtual range configuration based on the received plurality of instructions, wherein the alternate virtual range configuration utilizes less than the determined amount of computed resource utilized by the virtual range.

19. The system of claim 18, wherein the memory contains further instructions which when executed by the processing circuitry further configures the system to:
detect an instruction for deploying an application in the plurality of instructions, the application deployed on a first virtual instance;
determine that the application can be executed on a second virtual instance requiring less compute resources than the first virtual instance; and
generate the alternate virtual range configuration to deploy the second virtual instance in place of the first virtual instance.
